(19) United States
(12) Patent Application Publication
(10) Pub. No.: US 2002/0062767 A1
(43) Pub. Date: May 30, 2002

(54) Safe

(76) Inventor: James T. Walker, Beverly Hills, CA (US)

Correspondence Address: Michael Zarrabian, Esq., Suite 500, 1925 Century Park East, Los Angeles, CA, 90067, US

(21) Appl. No.: 09/727,640

(22) Filed: Nov. 30, 2000

(51) Int. Cl. E06B 7/00

(52) U.S. Cl. 109/67

(57) ABSTRACT

A security safe having a housing defining a security enclosure, the housing including an opening into an interior of said enclosure for placing items into, and removing items from, said enclosure. A door mechanism is mounted to the housing for movement between opened and closed positions in relation to said opening, wherein in the closed position the door mechanism precludes access to said interior through said opening. In one version, the housing further includes an aperture for inserting items into said enclosure without moving said door mechanism into the opened position. In another version the aperture is defined in a door of the safe.

### FIELD OF THE INVENTION

The present invention relates in general to enclosures for protecting valuables, an in particular to lock boxes for universities and colleges.

### BACKGROUND OF THE INVENTION

There has been a need for safe boxes in public and semi-public locations. For example, in universities, with the prolification of electronic devices such as laptop computers, cell phones and the like, many students find the need for a way to securely store their electronic equipment and other valuables. Many students in schools and universities use laptop computers, and increasingly many education institutions requires the students to have laptops. Some universities provide lockers near class rooms wherein a student can store objects in a locker. However, such lockers have many disadvantages. There usually are less lockers available than the number of students who need lockers. The locker door must be opened and closed every time an item is placed, or removed from the locker. Further, onlookers can see the valuable items being placed into or removed from a locker, and contents of the locker are exposed to public view every time the locker is opened. This poses a privacy and security risk. Further, for students living in dormitory rooms, currently there are no means of securely storing valuables such as laptops, cell phones, money, jewelry, etc., in the dormitory rooms. Theft from dormitory rooms are common, and often dormitory rooms are shared, thereby increasing the risk of theft.

There is, therefore, a need for a safe box for storing objects such as valuables in public and semi-public locations such as university dormitory rooms. There is also a need for such a safe box to allow placing objects into the safe box without exposing the contents of the safe box. There is also a need for such a safe box to allow securing the safe box to prevent removal.

### SUMMARY OF THE INVENTION

The present invention satisfies these needs. In one embodiment, the present invention provides a security safe having a housing defining a security enclosure, the housing including an opening into an interior of said enclosure for placing items into, and removing items from, said enclosure. A door mechanism is mounted to the housing for movement between opened and closed positions in relation to said opening, wherein in the closed position the door mechanism precludes access to said interior through said opening. In one version, the housing further includes an aperture for inserting items into said enclosure without moving said door mechanism into the opened position. In another version, the aperture is defined in a door of the safe. The safe includes means for locking the doors, and anchoring means for anchoring the safe to a structure.

### BRIEF DESCRIPTION OF THE DRAWINGS

These and other features, aspects and advantages of the present invention will become better understood with regard to the following description, appended claims and accompanying drawings where:

FIG. 1 shows an example perspective view of an embodiment of a safe according to the present invention with the safe doors in the closed position;

FIG. 2 shows an example perspective view of the safe of FIG. 1 with the safe doors in the open position;

FIG. 3 shows an example perspective view of the safe of FIG. 1 with the safe doors removed, showing an example shelving for storage compartments within the safe;

FIG. 4 shows a partial top view of the safe of FIG. 1; and

FIG. 5 shows a front view of the safe of FIG. 1.

### DETAILED DESCRIPTION OF THE INVENTION

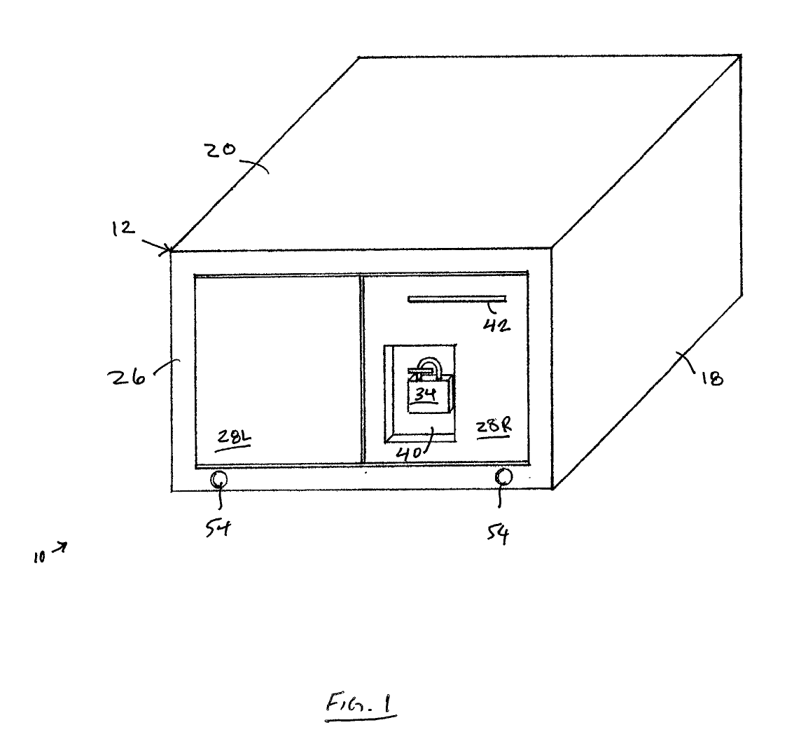

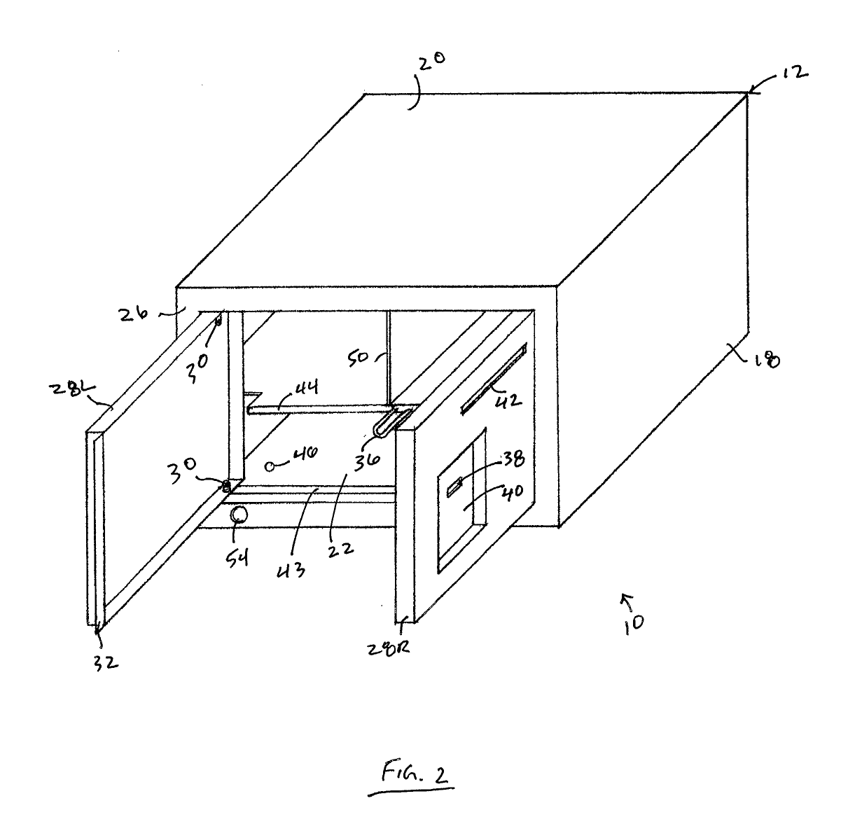

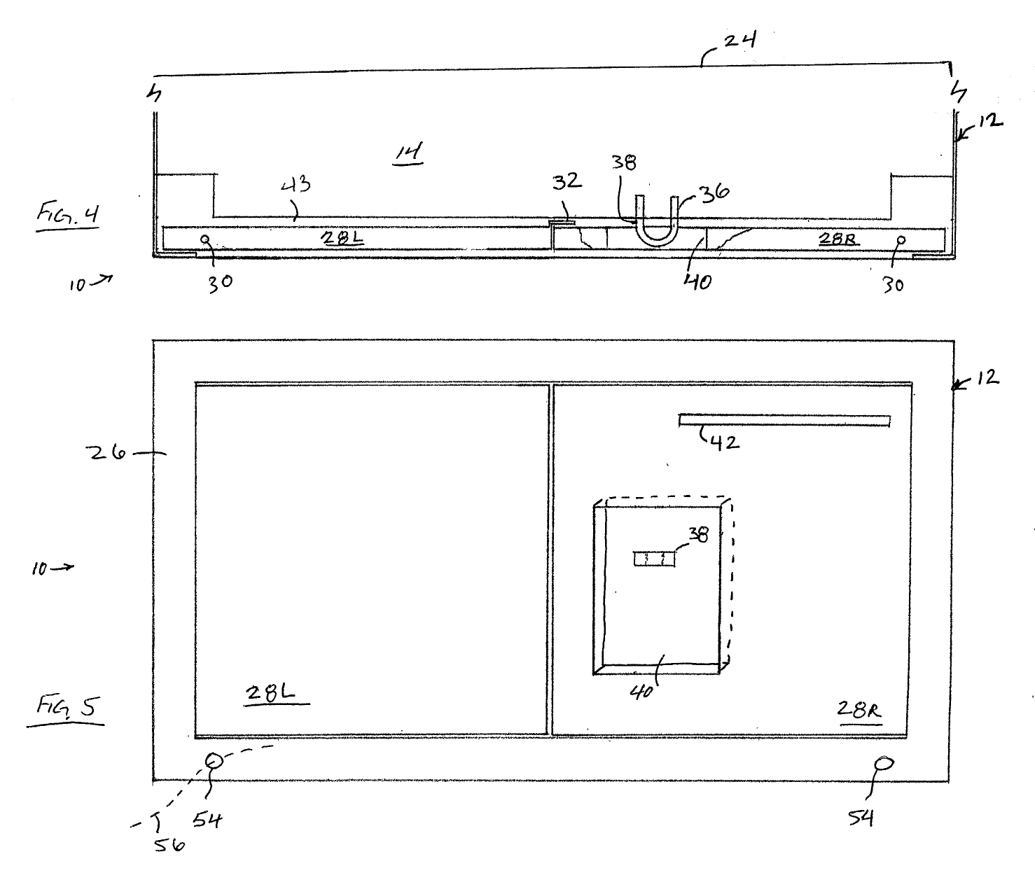

FIGS. 1-2 show perspectives view of an example embodiment of a safe 10 according to the present invention for securely storing valuables therein. The safe 10 comprises a housing 12 defining an enclosure 14, with an access-opening 16 providing access to the interior of the housing 12 for storing objects such as valuables. The housing 12 includes side walls 18, top wall 20, bottom wall 22 and rear wall 24, and said access-opening 16 and a door mechanism 28 including one or more doors form a front wall 26 of the safe 10. Preferably, the door mechanism 28 includes two doors 28L and 28R as shown, wherein the doors 28L, 28R are attached to the housing 12 around the opening 16 using hinges 30 as shown in FIGS. 2 and 4. The hinges 30 are selected, and the doors 28L, 28R are attached to the housing 12 via the hinges 30, such that when the doors 28L, 28R are closed, the hinges 30 are not visible (FIG. 1). This provides a flush external surface for the safe 10 where the doors 28L, 28R are attached to the housing 12, and prevents removal of the doors 12 by manipulating the hinges 30 when the doors 28L, 28R are closed.

In one example, the safe 10 has outside dimensions of about e.g. 10″ high×17″ wide×12.5″ deep. The access-opening 16 is defined on the front wall 26 of the safe 10, wherein the access-opening 16 is about e.g. 8″ high×15″ wide. The housing 12 and the doors 28L, 28R are made from e.g. 18 Gauge steel that has a baked power coat finish. Other dimensions and rigid materials for the safe 10 are possible and contemplated by the present invention. Access to the safe 10 is controlled with the two outward swinging doors 28L, 28R that pivot on the concealed hinges 30.

The safe 10 includes a locking mechanism for locking the doors 28R, 28L closed. In one example, the right hand (second) door 28R traps the left hand (first) door 28L when closed, if the left hand door 28L is closed first. For example, the left hand door 28L can include a lip 32 extending from an edge of the door 28L, whereby the right hand door 28R traps the left door 28L as shown in FIG. 4. In this embodiment, the right hand door 28R is controlled in its opening and closing using a padlock 34 inserted through a member such as steel loop 36 that is welded to the inside of the housing 12 and projects through a breach 38 in the right hand door 28R, wherein the padlock can be placed through the hoop 36, preventing the doors 28L, 28R from being opened without removing the padlock. In this example, the hoop 36 is attached to a divider 44 secured inside the housing 12. Other locking mechanisms for the safe 10 are possible (e.g., combination lock) and contemplated by the present invention.

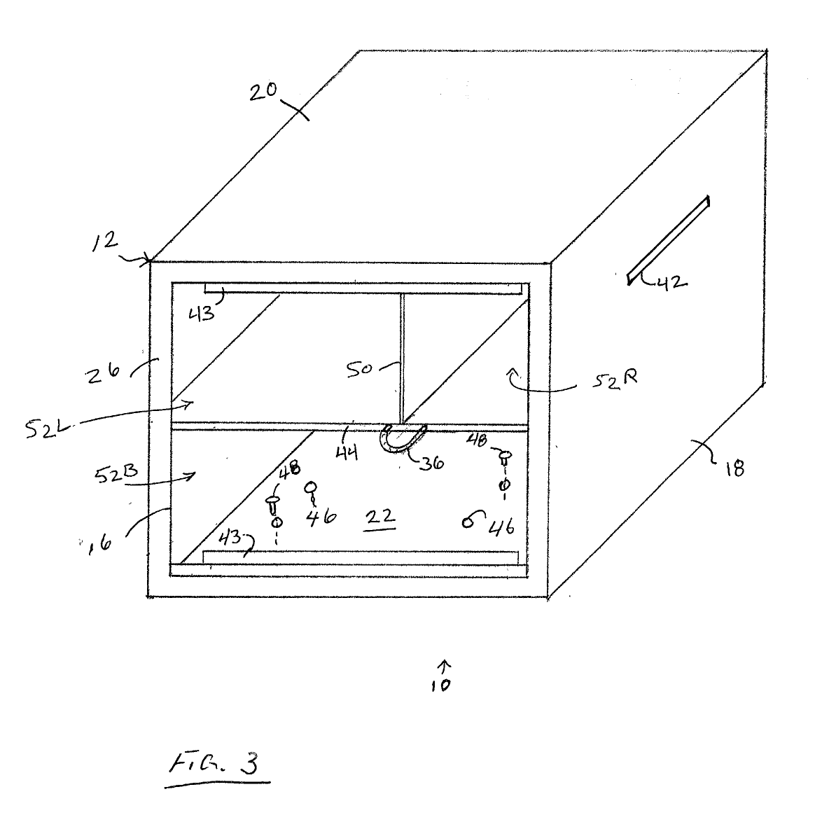

The right hand door 28R includes a recessed area 40 on the face of the right hand door 28R, wherein the breach 38 is defined in the recess 40 to provide an area for the padlock and a flush face to the safe. The hoop 36 projects through the breach 38 into the recessed area 40 (FIG. 4). As shown in FIG. 3, the doors 28L, 28R can be disassembled from the housing 12, when the doors 28L, 28R are open, by means of hand tools. This allows repairing or changing the doors 28L, 28R. Each door 28L, 28R is about e.g. 8″ high×7.5″ wide. The recessed area 40 on the right hand door 28R can be rectangular, about e.g. 4″ high×3″ wide×0.5″ deep. The breach 38 in the recessed area 40 can be about e.g. 1″ from top of the recess 40 and about 1″ wide. The housing 12 further includes lips 43 protruding from the opening 15, and recessed into the housing by e.g. 0.5 inches″, as door stops when the doors 28L, 28R are closed.

In another aspect of the present invention, the safe 10 further includes at least one aperture 42 for inserting items into the safe 10 without using said access-opening 16. As such, the aperture 42 can be used to insert items into the safe 10 without moving the doors 28 into the opened position. In one example shown in FIG. 5, the aperture 42 comprises a narrow horizontal slot defined in the right hand door 28R, wherein the slot is about e.g. ¼″ high and 5″ wide near the upper portion of the face of a door 28L or 28R. Other shapes, sizes and locations for the aperture 42 are possible and contemplated by the present invention. In another example shown in FIG. 3, the aperture 42 is defined in the housing 12, such as e.g. a side wall 18 of the housing 12. Preferably, the slot 42 is shaped and sized to allow inserting items into the safe 10, while preventing access to the interior 14 of the safe 10 for removing items therefrom when the safe doors 28L, 28R are closed. For example, the slot 42 can be used to insert items such as money, credit cards, mail, etc. into the safe 10 without opening the safe doors 28.

The safe 10 further includes a anchoring mechanism for securely fastening the safe to a structure, such as floor or walls boards, such that the safe 10 cannot be moved when the safe doors are closed. As shown in FIG. 3, in one example, the anchoring mechanism includes a plurality of orifices or holes 46 in the housing 12 to allow attachment of the safe 10 to a structure with fasteners 48, such that the fasteners cannot be removed when the doors 28L, 28R are in the closed position. For example, the safe 10 can be installed and anchored in the a student's dorm room using e.g. ¼″ anchor holes 46 in the bottom wall 22 of the housing 12 using fasteners 48 such as screws, nails, etc. The screws/nails 48 are inaccessible when the safe doors 28L, 28R are closed (FIG. 1). Other means of anchoring the safe 10 are possible and contemplated by the present invention.

As shown by example in FIG. 3, dividers/shelves 44, 50 are used to divide the interior space 14 in the safe into different storage area or compartments 52 (e.g, 52L, 52R, 52B). In the example of FIG. 3, dividers 44, 50 secured to the housing 12 (e.g., screwed) are used to define three storage areas 52L, 52R, 52B, wherein a horizontal shelf 44 divides the interior 14 in half into lower/bottom storage area 52B, and an upper area further divided by a vertical divider 50 into two unequal areas, a left area 52L and a right area 52R (e.g., area for the receipt of items inserted though said horizontal slot 42). The left hand upper interior portion 52L of the safe 10 can hold cameras, CD players, cell phones, and similar size personal items. The lower portion 52B of the safe 10 is designed to accommodate at least one portable or notebook personal computers.

As shown in FIG. 5, the safe 10 further includes one or more breaches/holes 54 providing access into the safe 10 for passing at least a power cable 56 therethrough for powering at least one electrical unit (e.g., notebook personal computer) in the safe 10 from an external power source when the doors 28L, 28R are closed. In the example shown, the breaches 54 are defined in the housing 12 (e.g., defined in the front wall 26 of the housing 12), and have a circular shape of about 1″ in diameter. Other shapes, sizes and locations for the breaches 54 are possible and contemplated by the present invention.

A safe 10 according to the present invention can be used in private, semi-public, and public locations. For example, the safe 10 can be used in homes, hotels, vehicles, and education institutions such as dormitory rooms. With the prolification of the notebook personal computer, theft of such items has become more important to students. Currently students have no way of storing their notebook computers and valuables and small expensive items in their dorm room. As such, the students have no choice but and they carry all of their valuables around with them at all times. An example safe 10 according the present invention takes little space in crowded dorm rooms, and can be locked by a lock such as a padlock or combination lock. Preferably, the student provides a lock which only the student can unlock. The lock can also be integrated into the safe 10. However, integrated mechanical combination locks or digital keypads can create a control/administration overhead for university management. The changing of codes for each student every semester can be difficult and time consuming. A lock provided by a student prevents management access to the student's belongings stored in the safe.

Students can store their belongings such as notebook computers, mail, cell phones, CD players, and other high value small items in the safe 10 in their dorm rooms, whereby the students total control over the contents of the safe 10 using the student's own lock. The student can conveniently deposit money and letters into the safe 10 using the drop aperture 42 without opening the safe doors 28L, 28R exposing contents of the safe 10. The safe 10 is designed for maximum space utilization and provides secure and private storage without using too much of the student's limited dorm room space. The inside shelf surfaces of the safe 10 can be covered with a rubber type material.

Although the present invention has been described in considerable detail with regard to the preferred versions thereof, other versions are possible. Therefore, the appended claims should not be limited to the descriptions of the preferred versions contained herein.

What is claimed is:

1. A security safe comprising:
a housing defining a security enclosure, the housing including an opening into an interior of said enclosure for placing items into, and removing items from, said enclosure,
a door mechanism mounted to the housing for movement between opened and closed positions in relation to said opening, wherein in the closed position the door mechanism precludes access to said interior through said opening,
wherein the housing further includes an aperture for inserting items into said enclosure without moving said door mechanism into the opened position.

2. The safe of claim 1, wherein the aperture defines a slot through which items can be inserted into said enclosure.

3. The safe of claim 2, wherein the aperture defines a narrow slot to prevent reaching inside the safe by hand.

4. The safe of claim 1, wherein the door mechanism comprises at least a door attached to the housing by one or more hinges such that the door is movable between said opened and closed positions.

5. The safe of claim 4, wherein the hinges are concealed from view by the housing and the door when the door mechanism is in the closed position.

6. The safe of claim 1, wherein the door mechanism comprises a first door and a second door, each door attached to the housing by one or more hinges whereby each door can swing between an opened position and a closed position in relation to said opening, wherein in the closed position the doors cooperatively preclude access to said interior through said opening.

7. The safe of claim 6, wherein when the first door is placed in the closed position, the second door traps the first door in the closed position when the second door is placed in the closed position, whereby the first door can be placed in the opened position only after the second door is placed in the opened position.

8. The safe of claim 6, wherein access to the interior of said enclosure is controlled by swinging at least one door from the closed position away from the housing to the opened position.

9. The safe of claim 6, wherein the hinges are concealed from view by the housing and the doors when the door mechanism is in the closed position.

10. The safe of claim 6 further comprising a locking mechanism for locking the doors in the closed position.

11. The safe of claim 10, wherein the locking mechanism comprises at least one member attached to the housing and projecting through a breach defined in at least one door when that door is in the closed position, the member including a hole for passing a lock therethrough, thereby keeping said at least one door in the closed position.

12. The safe of claim 11, wherein said at least one door includes a recessed portion having the breach thereon, such that said member projects through the breach into the recessed area when said at least one door is in the closed position.

13. The safe of claim 7 further comprising a locking mechanism including a member attached to the housing and projecting through a breach defined in said second door when the second door is in the closed position, the member including a hole for passing a lock therethrough such that when the doors are closed such that the second door traps the first door, the locking mechanism keeps the doors in the closed position.

14. The safe of claim 1, further comprising shelving dividers mounted within the enclosure for receiving and supporting items of various shapes and sizes.

15. The safe of claim 1, further comprising shelving dividers mounted within the enclosure for receiving and supporting at least a portable personal computer.

16. The safe of claim 1, further comprising at least one breach providing access into said enclosure for passing at least a power cable therethrough for powering at least one electrical unit in the safe when the door mechanism is in the closed position.

17. The safe of claim 1, further comprising anchoring mechanism for securely fastening the safe to a structure.

18. The safe of claim 1, further including a plurality of orifices in said housing to allow attachment of said housing to a structure with fasteners, such that the fasteners cannot be removed when the door mechanism is in the closed position.

19. The safe of claim 1, wherein the housing includes side, top, bottom and rear walls, and said opening and at least one door form a front wall of the safe.

20. A security safe comprising:
a housing defining a security enclosure, the housing including an opening into an interior of said enclosure for placing items into, and removing items from, said enclosure,
a door mechanism mounted to the housing for movement between opened and closed positions in relation to said opening, wherein in the closed position the door mechanism precludes access to said interior through said opening,
wherein the door mechanism further includes at least an aperture for inserting items into said enclosure without moving said door mechanism into the opened position.

21. The safe of claim 20, wherein the aperture defines a slot through which items can be inserted into said enclosure.

22. The safe of claim 21, wherein the aperture defines a narrow slot to prevent reaching inside the safe by hand.

23. The safe of claim 20, wherein the door mechanism comprises at least a door attached to the housing by one or more hinges such that the door is movable between said opened and closed positions, wherein the aperture is defined in at least one of the doors.

24. The safe of claim 23, wherein the hinges are concealed from view by the housing and the door when the door mechanism is in the closed position.

25. The safe of claim 20, wherein the door mechanism comprises a first door and a second door, the aperture being defined in one door, each door attached to the housing by one or more hinges whereby each door can swing between an opened position and a closed position in relation to said opening, wherein in the closed position the doors cooperatively preclude access to said interior through said opening.

26. The safe of claim 25, wherein when the first door is placed in the closed position, the second door traps the first door in the closed position when the second door is placed in the closed position, whereby the first door can be placed in the opened position only after the second door is placed in the opened position.

27. The safe of claim 25, wherein access to the interior of said enclosure is controlled by swinging at least one door from the closed position away from the housing to the opened position.

28. The safe of claim 25, wherein the hinges are concealed from view by the housing and the doors when the door mechanism is in the closed position.

29. The safe of claim 25 further comprising a locking mechanism for locking the doors in the closed position.

30. The safe of claim 29, wherein the locking mechanism comprises at least one member attached to the housing and projecting through a breach defined in at least one door when that door is in the closed position, the member including a hole for passing a lock therethrough, thereby keeping said at least one door in the closed position.

31. The safe of claim 30, wherein said at least one door includes a recessed portion having the breach thereon, such that said member projects through the breach into the recessed area when said at least one door is in the closed position.

32. The safe of claim 26 further comprising a locking mechanism including a member attached to the housing and projecting through a breach defined in said second door when the second door is in the closed position, the member including a hole for passing a lock therethrough such that when the doors are closed such that the second door traps the first door, the locking mechanism keeps the doors in the closed position.

33. The safe of claim 20, further comprising shelving dividers mounted within the enclosure for receiving and supporting items of various shapes and sizes.

34. The safe of claim 20, further comprising shelving dividers mounted within the enclosure for receiving and supporting at least a portable personal computer.

35. The safe of claim 20, further comprising at least one breach providing access into said enclosure for passing at least a power cable therethrough for powering at least one electrical unit in the safe when the door mechanism is in the closed position.

36. The safe of claim 20, further comprising anchoring mechanism for securely fastening the safe to a structure.

37. The safe of claim 20, further including a plurality of orifices in said housing to allow attachment of said housing to a structure with fasteners, such that the fasteners cannot be removed when the door mechanism is in the closed position.

38. The safe of claim 20, wherein the housing includes side, top, bottom and rear walls, and said opening and at least one door form a front wall of the safe.

39. A security safe comprising:
a housing defining a security enclosure, the housing including an opening into an interior of said enclosure for placing items into, and removing items from, said enclosure,
a door mechanism mounted to the housing for movement between opened and closed positions in relation to said opening, wherein in the closed position the door mechanism precludes access to said interior through said opening,
the door mechanism comprising a first door and a second door, the aperture being defined in one door, each door attached to the housing by one or more hinges whereby each door can swing between an opened position and a closed position in relation to said opening, wherein in the closed position the doors cooperatively preclude access to said interior through said opening,
locking mechanism for locking the doors in the closed position, and
anchoring mechanism for securely fastening the safe to a structure.

40. The safe of claim 39, wherein the aperture defines a slot through which items can be inserted into said enclosure.

41. The safe of claim 40, wherein the aperture defines a narrow slot to prevent reaching inside the safe by hand.

42. The safe of claim 39, wherein when the first door is placed in the closed position, the second door traps the first door in the closed position when the second door is placed in the closed position, whereby the first door can be placed in the opened position only after the second door is placed in the opened position.

43. The safe of claim 39, wherein access to the interior of said enclosure is controlled by swinging at least one door from the closed position away from the housing to the opened position.

44. The safe of claim 39, wherein the hinges are concealed from view by the housing and the doors when the door mechanism is in the closed position.

45. The safe of claim 39, wherein the locking mechanism comprises at least one member attached to the housing and projecting through a breach defined in at least one door when that door is in the closed position, the member including a hole for passing a lock therethrough, thereby keeping said at least one door in the closed position.

46. The safe of claim 46, wherein said at least one door includes a recessed portion having the breach thereon, such that said member projects through the breach into the recessed area when said at least one door is in the closed position.

47. The safe of claim 39 wherein the locking mechanism includes a member attached to the housing and projecting through a breach defined in said second door when the second door is in the closed position, the member including a hole for passing a lock therethrough such that when the doors are closed such that the the second door traps the first door, the locking mechanism keeps the doors in the closed position.

48. The safe of claim 39, further comprising shelving dividers mounted within the enclosure for receiving and supporting items of various shapes and sizes.

49. The safe of claim 39, further comprising shelving dividers mounted within the enclosure for receiving and supporting at least a portable personal computer.

50. The safe of claim 39, further comprising at least one breach providing access into said enclosure for passing at least a power cable therethrough for powering at least one electrical unit in the safe when the door mechanism is in the closed position.

51. The safe of claim 39, wherein the anchoring mechanism includes a plurality of orifices in said housing to allow attachment of said housing to a structure with fasteners, such that the fasteners cannot be removed when the door mechanism is in the closed position.

52. The safe of claim 39, wherein the housing includes side, top, bottom and rear walls, and said opening and at least one door form a front wall of the safe.
